(19) United States
(12) Patent Application Publication
(10) Pub. No.: US 2010/0126524 A1
(43) Pub. Date: May 27, 2010

(54) SYSTEMS, METHODS AND SOLUTIONS FOR CLEANING CRYSTAL GROWTH VESSELS

(76) Inventor: Guoming Fan, Beijing (CN)

Correspondence Address: DLA PIPER LLP (US ), 2000 UNIVERSITY AVENUE, EAST PALO ALTO, CA, 94303-2248, US

(21) Appl. No.: 12/581,160

(22) Filed: Oct. 19, 2009

(30) Foreign Application Priority Data
Nov. 20, 2008 (CN) 200810180950.1

(51) Int. Cl. C11D 3/04; C23G 1/02

(52) U.S. Cl. 134/3; 134/22.1; 510/109; 510/179

(57) ABSTRACT

The disclosure provides mixed acid solutions for cleaning a vessel, such as a vessel used for growing a GaAs crystal, comprising nitric acid, hydrofluoric acid and water. Further, the disclosure also provides exemplary methods for cleaning a vessel for growing a GaAs crystal, by: a) immersing the vessel in a mixed acid solution; b) immersing the vessel in an ammonia solution; c) cleansing the vessel with a surfactant solution under supersonic vibration; and d) cleansing the vessel with deionized water under supersonic vibration.

### CROSS-REFERENCE TO RELATED APPLICATIONS

This application is based upon and claims benefit/priority of prior Chinese patent application No. 200810180950.1, filed Nov. 20, 2008, the disclosure of which is hereby incorporated by reference in its entirety for all purposes.

### BACKGROUND

1. Field

The disclosure generally relates to cleaning solutions as well as cleaning methods and systems consistent with such solutions. More particularly, the disclosure relates to cleaning solutions as well as associated cleaning systems and methods for cleaning crystal growth vessels, such as those used for growing GaAs crystals.

2. Description of Related Information

Currently, GaAs crystals may be grown by the vertical gradient freezing (VGF) method in vessels such as a boron nitride crucible and a quartz ampoule. After the GaAs crystals are grown, the boron nitride crucible and the quartz ampoule require cleaning for repeated use. If the boron nitride crucible and the quartz ampoule are not cleaned to fully remove any residues deposited on them, and are further used to grow GaAs crystals, the yield of the qualified GaAs crystals (the ratio of the length of the qualified crystal in the resulting crystal ingot to the whole length of the resulting crystal ingot×100%) would be low.

The most widely used cleaning method for cleaning GaAs crystals includes the following steps: subjecting the vessels to a first immersing process in which the vessels are immersed in a solution of nitrohydrochloric acid, ammonia and hydrogen peroxide; cleansing the vessels with deionized water; subjecting the vessels to a second immersing process in which the vessels are immersed in a hydrofluoric acid solution; cleansing the vessels with deionized water; subjecting the vessels to repeated cleansing with deionized water under supersonic vibration; and finally, subjecting the vessels to dehydration with ethanol. This method however, is costly because the nitrohydrochloric acid and hydrogen peroxide are unstable and need to be replaced every few hours and thus, are consumed in large amounts. In addition, this method involves lengthy procedures and only achieves low cleaning efficiency. In the first three cleanings with deionized water under supersonic vibration, for example, water must be heated to and maintained at 80° C. for a long period of time.

According to another existing technique, a method is disclosed in which the crucible is cleaned with concentrated sulfuric acid and sodium hydroxide. This method, however, introduces sodium ions and thus, presents the risk of negatively affecting the electric properties of the resulting GaAs crystal. Also, this method is complex, energy-consuming, low in inefficiency and security, and is costly. For example, the crucible is heated several times, and the heated nitrohydrochloric acid cannot be re-used, leading to a high cost for the chemical reagents.

As such, present techniques can be costly, involve numerous additional components and/or procedures, and be otherwise inefficient, and there is a need for systems, methods and solutions overcoming such drawbacks.

### SUMMARY

Systems, methods, and solutions consistent with the innovations herein are directed to cleaning crystal growth vessels.

According to some exemplary implementations, the disclosure provides mixed acid solutions for cleaning a vessel, such as a vessel for growing a GaAs crystal, comprising nitric acid, hydrofluoric acid and water. The disclosure also provides exemplary systems and techniques for cleaning a vessel for growing a GaAs crystal, such as a method comprising the steps of: a) immersing the vessel in a mixed acid solution; b) immersing the vessel in an ammonia solution; c) cleansing the vessel with a surfactant solution under supersonic vibration; and d) cleansing the vessel with deionized water under supersonic vibration, wherein the mixed acid solution comprises nitric acid, hydrofluoric acid and water.

It is to be understood that both the foregoing general description and the following detailed description are exemplary and explanatory only and are not restrictive of the invention, as described. Further features and/or variations may be provided in addition to those set forth herein. For example, the present invention may be directed to various combinations and subcombinations of the disclosed features and/or combinations and subcombinations of several further features disclosed below in the detailed description.

### DESCRIPTION OF THE DRAWINGS

The accompanying drawings, which constitute a part of this specification, illustrate various implementations and aspects of the present invention and, together with the description, explain the principles of the invention. In the drawings:

FIG. 1 is a block diagram of an exemplary system consistent with certain aspects related to the innovations herein.

FIG. 2 is a flow chart illustrating an exemplary method of cleaning a vessel consistent with certain aspects related to the innovations herein.

### DETAILED DESCRIPTION OF EXEMPLARY IMPLEMENTATIONS

Reference will now be made in detail to the invention, examples of which are illustrated in the accompanying drawings. The implementations set forth in the following description do not represent all implementations consistent with the claimed invention. Instead, they are merely some examples consistent with certain aspects related to the invention. Wherever possible, the same reference numbers will be used throughout the drawings to refer to the same or like parts.

The disclosure provides mixed acid solutions for cleaning a vessel for growing a GaAs crystal, comprising nitric acid, hydrofluoric acid and water. In one embodiment, the disclosure provides a mixed acid solution having a ratio by volume between the nitric acid, hydrofluoric acid and water of about: 1-6/0.1-1.5/0.1-1.5, respectively. In another embodiment, the disclosure provides a mixed acid solution of nitric acid, hydrofluoric acid and water in a ratio of about: 2-5/0.5-1.2/0.5-1.2, respectively. In another embodiment, the disclosure provides a mixed acid solution having a ratio by volume between the nitric acid, hydrofluoric acid and water of about: 3-4.5/1.0/1.0, respectively. In still another embodiment, the disclosure provides a mixed acid solution having a ratio by volume between the nitric acid, hydrofluoric acid and water of about: 4.0/1.0/1.0, respectively.

The disclosure also provides methods for cleaning a vessel for growing a GaAs crystal, comprising the steps of: a) immersing the vessel in a mixed acid solution; b) immersing the vessel in an ammonia solution; c) cleansing the vessel with a surfactant solution under supersonic vibration; and d) cleansing the vessel with deionized water under supersonic vibration, wherein the mixed acid solution comprises nitric acid, hydrofluoric acid and water. In another embodiment, the disclosure provides a method for cleaning a vessel for growing a GaAs crystal, wherein the mixed acid solution of nitric acid, hydrofluoric acid and water is in a ratio by volume of about: 1-6/0.1-1.5/0.1-1.5, respectively. In another embodiment, the disclosure provides a method for cleaning a vessel for growing a GaAs crystal, wherein the mixed acid solution of nitric acid, hydrofluoric acid and water is in a ratio by volume of about: 2-5/0.5-1.2/0.5-1.2, respectively. In another embodiment, the disclosure provides a method for cleaning a vessel for growing a GaAs crystal, wherein the mixed acid solution of nitric acid, hydrofluoric acid and water is in a ratio by volume of about: 3-4.5/1.0/1.0, respectively. In another embodiment, the disclosure provides a method for cleaning a vessel for growing a GaAs crystal, wherein the mixed acid solution of nitric acid, hydrofluoric acid and water is in a ratio by volume of about: 4.0/1.0/1.0, respectively.

The mixed acid solutions are stable for a relatively long time and therefore, allows for less frequent replacement of the formulating cleaning solution. In addition, the disclosed methods provide an improved removal rate of the residues, e.g. GaAs, and boron oxide, on the vessel and thus, reduces the time for immersing, improving removal efficiency and diminishing cleaning cost.

The disclosed mixed acid solutions of concentrated nitric acid, concentrated hydrofluoric acid and deionized water, may be prepared by mixing concentrated nitric acid, concentrated hydrofluoric acid and deionized water together, optionally with agitation.

The disclosed methods for cleaning a vessel for growing a GaAs crystal, comprising the steps of: a) immersing the vessel in a mixed acid solution; b) immersing the vessel in an ammonia solution; c) cleansing the vessel with a surfactant solution under supersonic vibration; and d) cleansing the vessel with deionized water under supersonic vibration.

In the disclosed methods, the vessel for growing a GaAs crystal optionally includes a crucible and quartz ampoule. The crucible may be a boron nitride crucible and the vessel may be new or used.

After the vessel is immersed in the mixed acid solution, it is further immersed in ammonia for neutralizing any residual acid solution on the vessel. As ammonia is susceptible to vaporization, it is easy to remove in the subsequent procedures.

After the vessel for growing a GaAs crystal is immersed in ammonia, it may be subjected to a procedure of cleansing the vessel with a nonionic surfactant solution (such as a diluted solution of TW-80, i.e. polysorbate(80)) under supersonic vibration, for the purpose of removing ammonia and any particles from the vessel surface and facilitating their further removal in subsequent procedures. In this procedure, the surfactant may be TW-80 as this surfactant does not include metal ions and thus, does not negatively affect the quality of the resulting GaAs crystal. In addition, TW-80 is susceptible to dissolution in water, and displays weak adsorption to and thus, is easy to remove from the vessel surface.

After undergoing the procedure of cleansing the vessel with a nonionic surfactant solution under supersonic vibration, the vessel is subjected to a procedure of cleansing the vessel with deionized water under supersonic vibration, for the purpose of removing the residual nonionic surfactant and ammonia on the vessel surface.

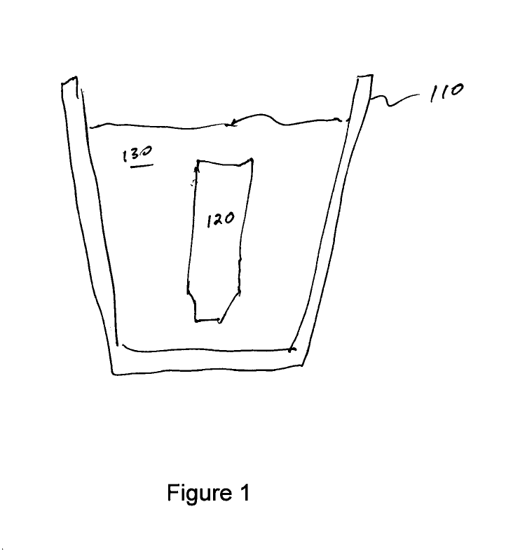

FIG. 1 illustrates an exemplary system for cleaning crystal growth vessels, such as vessels for growing GaAs crystal. According to the illustrative system, here, an exemplary system may comprise a receptacle 110 in relation to which cleaning of a crystal growth vessel 120 occurs, and a mixed acid solution 130 for cleaning the vessel, comprising nitric acid, hydrofluoric acid and water, among the other receptacles and components set forth herein.

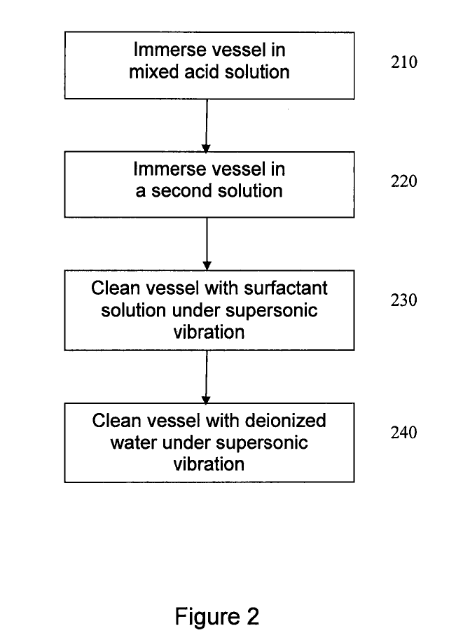

FIG. 2 illustrates an exemplary method of cleaning a vessel consistent with certain aspects related to the present invention. In the example illustrated here, there is provided a method for cleaning a vessel for growing a GaAs crystal. Moreover, the method may include immersing the vessel in a mixed acid solution (210), immersing the vessel in a second solution (220) such as an ammonia solution, cleansing the vessel with a surfactant solution under supersonic vibration (230), and cleansing the vessel with deionized water under supersonic vibration (240), wherein the mixed acid solution comprises nitric acid, hydrofluoric acid and water, and/or any of the other solutions set forth herein.

According to another implementation, an exemplary method herein may be carried out as follows:
1. Subjecting a PNB (i.e. vessel for growing a GaAs crystal, made of pyrolytic boron nitride) to be cleaned to immersing in a mixed acid solution comprising nitric acid, hydrofluoric acid and water;
2. Cleansing the vessel with deionized water;
3. Immersing the vessel in an ammonia solution;
4. Cleansing the vessel with deionized water;
5. Cleansing the vessel with a diluted TW-80 solution with heating under supersonic vibration;
6. Cleansing the vessel with deionized water with heating under supersonic vibration; and
7. Dehydrating the vessel with ethanol.

The disclosed mixed acid solutions, systems methods for cleaning vessels for growing GaAs crystal make it possible to reduce cost, simplify various procedures involved, and improve cleaning efficiencies.

For further illustration of various aspects of the present disclosure, several specific examples will now be described. It should be understood however that these examples are for illustrative purposes only, and are not intended to limit the scope of the present disclosure.

### EXAMPLES

### Example 1

### Mixed Acid Solution Ratio of about: 4.0/1.0/1.0

A mixed acid solution with a ratio by volume of nitric acid:hydrofluoric acid:water of about 4.0/1.0/1.0, respectively was prepared. This solution was stored for 55 days and was used for cleaning 8 crucibles for growing a GaAs crystal (made of pyrolytic boron nitride) in the following mode:
1. Subjecting 8 used crucibles to immersing in the mixed acid solution for 20 minutes;
2. Cleansing the crucibles with deionized water 2 times;
3. Immersing the crucibles in an ammonia solution (ratio by volume of ammonia:water being 1:5) for 10 minutes;
4. Cleansing the crucibles with deionized water 2 times;
5. Cleansing the crucibles with a diluted TW-80 solution (concentration by weight being 0.0027%) at 80° C. under supersonic vibration for 1 hour;
6. Cleansing the crucible with deionized water at 80° C. under supersonic vibration for 30 minutes; and
7. Dehydrating the crucibles with ethanol.

After step 1 is finished, the crucibles were visually observed under light and were found to be free of any solid left on their surface.

After dehydration and drying, the crucibles were further used for growing GaAs crystals by the VGF method. The results were summarized in Table 1. From Table 1, it can be seen that the disclosed mixed acid solution leads to improved cleaning efficiency and a yield of qualified products higher than prior art.

The total time for carrying out the above steps 1-7 was 161 minutes (including handling time and the time taken for the operation of the equipments), leading to a rate of 2.98 crucibles per hour.

### Example 2

### Comparative Example

For the purpose of comparison, the following prior art method was carried out to clean crucibles for growing a GaAs crystal (made of pyrolytic boron nitride):
1. Immersing 8 used crucibles for growing a GaAs crystal (made of pyrolytic boron nitride) in nitrohydrochloric acid for 60 minutes;
2. Cleansing the crucibles with deionized water 3 times;
3. Immersing the crucibles in a hydrofluoric acid solution for 20 minutes;
4. Cleansing the crucibles with deionized water 7 times;
5. Cleansing the crucibles with deionized water under supersonic vibration for 5 times, with fresh water each time, the first three times carried out at 80° C., the five times taking 9.3 hours; and
6. Dehydrating the crucibles with ethanol.

After step 1 is finished, the crucibles were visually observed under light and were found to be free of any solid left on their surface.

After dehydration and drying, the crucibles were further used for growing GaAs crystals by the VGF method. The results were summarized in Table 1.

The total time for carrying out the above steps 1-6 was 692 minutes (including handling time and the time taken for the operation of the equipments), leading to a rate of 0.69 crucible per hour.

TABLE 1
GaAs Crystals Grown With Re-Used Crucibles

| | Crystals | | | | |
|---|---|---|---|---|---|
| | 3/Zn¹ | 4/Si | 4/c | 4/Zn | 6/c |
| Example 1: | 47.90%² | 41.60% | 40.97% | 57.41% | 44.01% |
| Mixed acid solution | | | | | |
| ratio of about: | | | | | |
| 4.0/1.0/1.0 | | | | | |
| Example 2: | 30.35% | 40.15% | 37.03% | 49.19% | 41.63% |
| Comparative example | | | | | |
| % Improvement | 17.55% | 1.45% | 3.94% | 8.22% | 2.38% |

Notes:
¹3/Zn represents a GaAs crystal doped with Zn with a diameter of 3 inches (76.2 mm) (similar for the other crystals), with the numeral on the left side of the slash referring to diameter of the crystal and the symbol on the right side referring to the dopant.
²Yield of the qualified product = (the length of the qualified product of the resulting crystal ingot/the total length of the resulting crystal ingot) × 100%

While the present disclosure has been particularly shown and described with reference to several embodiments thereof, it will be understood by those of ordinary skill in the art that various changes in form and details may be made thereto without departing from the principles and spirit of the present disclosure, the proper scope of which is defined in the following claims and their equivalents.

1. A mixed acid solution for cleaning a vessel for growing a GaAs crystal, comprising nitric acid, hydrofluoric acid and water.

2. The mixed acid solution of claim 1, wherein the ratio by volume between nitric acid, hydrofluoric acid and water is about: 1-6/0.1-1.5/0.1-1.5, respectively.

3. The mixed acid solution of claim 2, wherein the ratio by volume between nitric acid, hydrofluoric acid and water is about: 2-5/0.5-1.2/0.5-1.2, respectively.

4. The mixed acid solution of claim 3, wherein the ratio by volume between nitric acid, hydrofluoric acid and water is about: 3-4.5/1.0/1.0, respectively.

5. The mixed acid solution of claim 4, wherein the ratio by volume between nitric acid, hydrofluoric acid and water is about: 4.0/1.0/0.0, respectively.

6. The mixed acid solution of claim 1, wherein the vessel for growing a GaAs crystal includes crucible and quartz ampoule.

7. A method for cleaning a vessel for growing a GaAs crystal, the method comprising the steps of:
a) immersing the vessel in a mixed acid solution;
b) immersing the vessel in an ammonia solution;
c) cleansing the vessel with a surfactant solution under supersonic vibration; and
d) cleansing the vessel with deionized water under supersonic vibration, wherein the mixed acid solution comprises nitric acid, hydrofluoric acid and water.

8. The method of claim 7, wherein the ratio by volume between nitric acid, hydrofluoric acid and water is about: 1-6/0.1-1.5/0.1-1.5, respectively.

9. The method of claim 8, wherein the ratio by volume between nitric acid, hydrofluoric acid and water is about: 2-5/0.5-1.2/0.5-1.2, respectively.

10. The method of claim 9, wherein the ratio by volume between nitric acid, hydrofluoric acid and water is about: 3-4.5/1.0/1.0, respectively.

11. The method of claim 10, wherein the ratio by volume between nitric acid, hydrofluoric acid and water is about: 4.0/1.0/1.0, respectively.

12. The method of claim 7, wherein the surfactant is TW-80.

13. The method of claim 7, wherein the vessel for growing the GaAs crystal includes a crucible and quartz ampoule.

14.-16. (canceled)

17. A method for cleaning a vessel for growing a crystal, the method comprising the steps of:
a) immersing the vessel in a mixed acid solution;
b) immersing the vessel in an ammonia solution;
c) cleansing the vessel with a surfactant solution under supersonic vibration; and
d) cleansing the vessel with deionized water under supersonic vibration, wherein the mixed acid solution comprises nitric acid, hydrofluoric acid and water.

18. The method of claim 17, wherein the ratio by volume between nitric acid, hydrofluoric acid and water is about: 2-5/0.5-1.2/0.5-1.2, respectively.

19.-20. (canceled)
